(19) United States
(12) Patent Application Publication
(10) Pub. No.: US 2021/0158249 A1
(43) Pub. Date: May 27, 2021

(54) SYSTEM FOR REQUIREMENT BASED INTELLIGENT RESOURCE ALLOCATION

(71) Applicant: TOOLSOUP LIMITED, Inverness (GB)

(72) Inventors: William Charles MacLean, Inverness (GB); Kyle Stephen Whittington, Edinburgh (GB); Russell Vincent Peterson, Glasgow (GB); Bettina Kern, Edinburgh (GB)

(73) Assignee: TOOLSOUP LIMITED, Inverness (GB)

(21) Appl. No.: 16/693,544

(22) Filed: Nov. 25, 2019

(51) Int. Cl. G06Q 10/06; G06F 16/248

(52) U.S. Cl. CPC G06Q 10/06313; G06F 16/248

(57) ABSTRACT

The invention provides systems, computer implement method, and computer program product for requirement based intelligent resource allocation, comprising electronically receiving, via a distributed network, information associated with at least one supplier, the information associated with the at least one supplier comprising at least a supplier type identifier, supplier availability, and supplier location data; electronically receiving, via a customer device operably connected to the distributed network, a service requirement request from a customer; identify potential suppliers for the service requirement request based on the information associated with the suppliers; determining whether the potential suppliers satisfy one or more predetermined conditions; displaying the availability that satisfies the one or more predetermined conditions to the customer; receiving a customer selection; and allocating the at least one of the potential suppliers based on at least the customer selection.

### FIELD OF THE INVENTION

The invention relates to improved systems, computer implemented methods, and computer program product for requirement based intelligent resource allocation.

### BACKGROUND

Identifying a resource to satisfy an existing requirement, typically requires verifying each resource manually to determine whether the resource satisfies a condition of a resource requirement under predetermined terms. Once the resources are identified, the results must typically be compared manually before choosing a resource. However, most resources are configured to satisfy a condition of the resource requirement under predetermined terms at a specific time. If the specific time is not available, the resource may no longer satisfy a condition of the resource requirement under the predetermined terms, and the process must begin again. Once a subset of the resources is identified, the remaining resources should typically be released for future use.

Existing automatic methods and apparatus for requirement-based resource allocation rely on multiple automatic and manual identification analysis. The design of database(s) and computer process(es) to facilitate automatic resource allocation has largely mirrored the ‘real world’ manual process(es) discussed above, replicating most of the existing issues, such as delays, with the ‘real world’ manual process(es). In today's fast-moving world such delays are less acceptable. These and other problems remain associated with the prior art.

As an example, to obtain a service, a customer may identify one or more suppliers local to the customer (or the location of the desired service), and contact each to discuss the service required, price, and available time slots. A customer may then compare the results manually before deciding upon a supplier. The customer must then contact the selected supplier, but if time has elapsed, the supplier may no longer be available at the selected time slot, and the customer must begin again. Existing automatic methods and apparatus for matching customer(s) and supplier(s) providing services continue to rely on a combination of automatic and manual interactions. As this design continues to implement ‘real world’ manual process(es) in an automated setting, existing issues such as delays seep into the automated systems.

The present invention seeks to alleviate one or more of the problems of the prior art.

US2019/0005562—CHEN THUMBTACK describes matching a request from a user to a set of different users for responding to the request.

US2018/0330335—FEI THUMBTACK describes method and apparatus for enabling scheduling of a meeting activity between a service professional and a customer of a service.

US2018/0255070—LIU THUMBTACK describes determining the legitimacy of messages using a message verification process. US2018/0241845—TSAY THUMBTACK describes a system for generating responses to requests. WO2018/148329—ZAPPACOSTA THUMBTACK describes automatically generating a response on behalf of a first user to a request received from a second user.

US2010/0174727 (and equivalents US2017/0236180, U.S. Pat. No. 9,177,056 AND U.S. Pat. No. 9,471,683)—ZAPPACOSTA THUMBTACK describe a method and apparatus for a trusted localised peer-to-peer services marketplace.

WO2018/203826—TANG describes an online marketplace for laundry service provider and requester.

US2006/0184381—RICE describes a computer implemented method and system for matching a consumer to a home service provider in which consumer leads are provided to a home services provider.

US2005/038688—COLLINS describes a system and method for matching local buyers and sellers for the provision of community-based services with results being presented back to the consumer so that the choice of which vendors to be contacted is left to the consumer.

U.S. Pat. No. 7,096,193—BEAUDOIN SERVICEMAGIC describes facilitating commerce among consumers and service providers by matching ready-to-act consumers and pre-qualified service providers, the service providers may choose to submit a response for the consumer's needs and after a sufficient number of responses have been received these are presented to the consumer.

CA2662786—SCHOENBERG describes connecting consumers with service providers in which an available service provider satisfying at least some of the attributes in the set of attributes is identified and a communication channel between the consumer and identified service provider is established.

US2002/038233—SHUBOV describes a system and method for matching professional service providers with consumers. The matching system cross references consumer answers with a database of service providers and the service providers can submit bids which are returned to the consumer.

US2010/274623—THOMAS describes a method of selecting and matching professionals. With a match, the repair persons and users are notified and they proceed to schedule the project.

### STATEMENTS OF THE INVENTION

In one aspect, a computer-implemented method for requirement based intelligent resource allocation is presented. The method comprising: electronically receiving, via a distributed network, information associated with at least one supplier, the information associated with the at least one supplier comprising at least a supplier type identifier, supplier availability, and supplier location data; storing the information associated with the at least one supplier in at least one database; electronically receiving, via a customer device operably connected to the distributed network, a service requirement request (12) from a customer, the service requirement request (12) comprising at least a service requirement identifier associated with a required service request, and service requirement location data; initiating a supplier allocation subroutine to query the database and identify potential suppliers for the service requirement request (12), wherein the supplier allocation subroutine is further configured to determine a match between the at least one supplier type identifier and the service requirement identifier, and the supplier location data and service requirement location data; electronically retrieving the potential suppliers based on at least the match; determining whether the potential suppliers satisfy one or more predetermined conditions, wherein the one or more predetermined conditions comprises availability within at least one predetermined time period; transmitting control signals configured to cause the customer device to display the availability that satisfies the one or more predetermined conditions; receiving, via the customer device, a customer selection, wherein the customer selection comprises an appointment having an associated date and time from the supplier availability associated with the potential suppliers that satisfies the one or more predetermined conditions; and allocating the at least one of the potential suppliers based on at least the customer selection.

In some embodiments, the method further comprises providing, in the at least one database, associations between the supplier type identifier and a supplier type price, and between the service requirement identifier and a service price, and, querying the database for the supplier type price and the service requirement price; determining a price for the service requirement request based on at least the supplier type price and the service requirement price; and providing the price, via the customer device, for the service requirement request to the customer.

In some embodiments, the method further comprises receiving, from the customer device, an indication that the customer has accepted the price for the service requirement request.

In some embodiments, the method further comprises, after selecting the appointment, initiating the supplier allocation subroutine to query the database and identify the potential suppliers for the service requirement request (12) by matching the supplier type identifier with the service requirement identifier, and the service requirement location data with the supplier location data; determining whether the identified potential suppliers satisfy the one or more predetermined conditions, wherein the one or more of the predetermined conditions comprises availability at the date and time of the selected appointment based on at least the match; and providing, via the customer device, confirmation of the availability of the identified potential supplier at the date and time of the selected appointment.

In some embodiments, the method further comprises providing, in the at least one database, associations between the supplier type identifier and least one supplier type price, and between the service requirement identifier and service price, and, after selecting the appointment, initiating the supplier allocation subroutine to query the database and identify potential suppliers for the service requirement request (12) by matching the supplier type identifier with the service requirement identifier, and the service requirement location data with the supplier location data; querying the database for the supplier type price and the service price; determining whether the identified potential suppliers satisfy the one or more predetermined conditions, wherein the one or more of the predetermined conditions comprises availability at the date and time of the selected appointment; providing, via the customer device, confirmation of the availability of the identified potential supplier at the date and time of the selected appointment; determining a price for the service requirement request based on at least the supplier type price and the service requirement price; and providing, via the customer device, the price for the service requirement request to the customer.

In some embodiments, the method further comprises receiving, via the customer device, an indication that the customer has accepted the price.

In some embodiments, the service requirement request (12) is temporarily stored as a cookie in the customer device.

In some embodiments, the method further comprises after the step of selecting the appointment by the customer, allocating a unique job identifier to the service requirement request (12), and creating a job record in the database using the unique job identifier and the data in the service requirement request (12).

In some embodiments, the method further comprises after the customer has accepted the price, or after the customer has accepted the price and entered payment information, allocating a unique job identifier to the service requirement request (12), and creating a job record in the database using the unique job identifier and the data in the service requirement request (12).

In some embodiments, the price for the service requirement request comprises at least one of: a preliminary price associated with at least one of the supplier type and service type; and, at least one of a system fee, a payment module fee, a notification module fee, a tracking module fee, a fulfilment module fee.

In some embodiments, the method further comprises in the step of identifying at least one supplier, identifying at least one supplier type, and where two or more supplier types are required for a service requirement request, identifying the supplier for each supplier type.

In some embodiments, the service requirement identifier for the service requirement request is associated with one supplier type identifier.

In some embodiments, the service requirement identifier for the service requirement request is associated with more than one supplier type identifier.

In some embodiments, the method further comprises determining that more than one supplier is available at the date and time of the selected appointment for the supplier type identifier;

and selecting the potential supplier for the supply type identifier either randomly, geographically, alphabetically, and/or in-turn.

In some embodiments, the at least one supplier, the customer, and an administrator are each assigned a unique user identifier and a unique user type identifier.

In some embodiments, the location data of at least one of the supplier location data, a customer location data, the service requirement location data, and a job location data comprises at least one of a location and a location range associated with that respective supplier, customer, service requirement or job.

In another aspect, a system for requirement based intelligent resource allocation is presented. The system comprising: a control module (40); at least one database (70, 80, 90); at least one user interface module providing at least one customer user interface (20) and at least one supplier user interface (30); and an appointments service module (45); further in which: the control module (40) is configured for electronically receiving, via a distributed network, information associated with at least one supplier, the information associated with the at least one supplier comprising at least a supplier type identifier, supplier availability, and supplier location data, and for receiving, via a customer device operably connected to the distributed network, a service requirement request (12) from a customer, the service requirement request (12) comprising at least a service requirement identifier associated with a required service request, and service requirement location data; storing the information associated with the at least one supplier in at least one database (70, 80, 90); the control module (40) is further configured for initiating a supplier allocation subroutine to query the database and identify potential suppliers for the service requirement request (12), wherein the supplier allocation subroutine is further configured to determine a match between the at least one supplier type identifier and the service requirement identifier, and the supplier location data and service requirement location data, and electronically retrieving the potential suppliers based on at least the match; the appointments module (45) is configured for determining whether the potential suppliers satisfy one or more predetermined conditions, wherein the one or more predetermined conditions comprises availability within at least one predetermined time period; the control module (40) is further configured for transmitting control signals configured to cause the customer device to display on the customer user interface (20), the availability that satisfies the one or more predetermined conditions; the customer user interface (20) is configured for receiving a customer selection, wherein the customer selection comprises an appointment having an associated date and time from the supplier availability associated with the potential suppliers that satisfies the one or more predetermined conditions; and the control module (40) is further configured for allocating the at least one of the potential suppliers based on at least the customer selection.

The features, functions, and advantages that have been discussed may be achieved independently in various embodiments of the present invention or may be combined with yet other embodiments, further details of which can be seen with reference to the following description and drawings.

### BRIEF DESCRIPTION OF THE FIGURES

The present invention will now be described, by way of example only, with reference to the following figures, further in which like reference numerals refer to the same features.

FIG. 1 shows a schematic view of a system for use in apparatus and methods, and in instructions for computing devices and systems, for connecting customer(s) and supplier(s) according to the invention.

FIG. 2 shows an example method for use in apparatus and methods, and in instructions for computing devices, for connecting customer(s) and supplier(s) according to a further embodiment of the invention.

### DETAILED DESCRIPTION OF THE INVENTION

The present invention provides the functional benefit of implementing unattended processes and self-updating procedures to accurately query and retrieve data from a database based on specific resource requirements under predetermined conditions. By reducing the amount of human influence in the process of connecting customer(s) with supplier(s), the present invention reduces errors on deployment, improves reliability, and increases the speed of implementing updates.

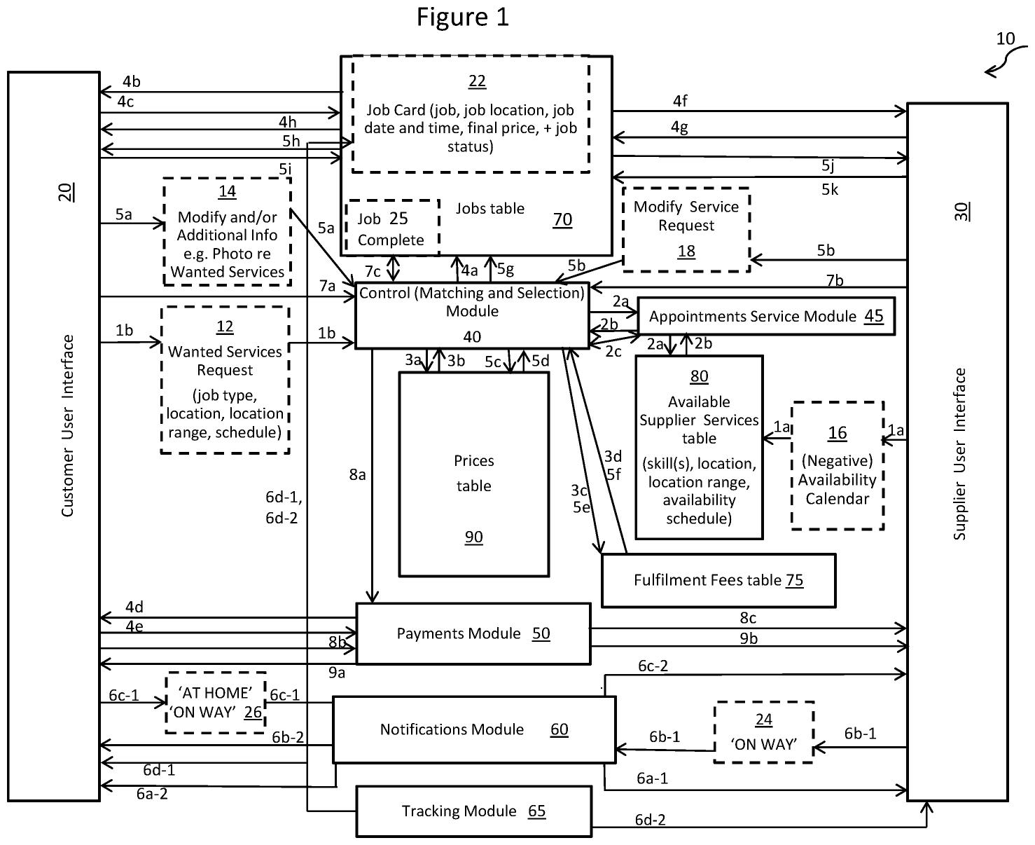

FIG. 1 shows a high-level diagram of a system 10 for apparatus(es), method(s) and computer instructions for connecting customers and suppliers. System 10 comprises a customer user interface 20 and a supplier user interface 30. A control (e.g. matching and selection) module 40 controls both customer user interface 20 and supplier user interface 30 and facilitates many elements and features of system 10. Control (e.g. matching and selection) module 40 is connected to, or further comprises as one or more sub-module(s), an appointments service module 45, and with a payments module 50, a notifications module 60, and, optionally, a tracking module 65. These latter ones may be provided wholly, or in part, by separate systems to which the present system 10 is connected. There may be costs associated with accessing these separate systems termed herein fulfilment fees. Optionally, a fulfilment fee table 75, and/or a separate fulfilment fee module which may retrieve fulfilment fee data from third party applications from time to time e.g. every hour or day or for each job, may be provided.

In this embodiment, system 10 further comprises at least one database, such as a relational database or a plurality of separate databases. Here, one database is provided (not labelled), preferably a relational database, which may have at least three data holding components known as tables, here a jobs table 70, an available services table 80 and a prices table 90. It will be understood by someone skilled in the art that the tables may form one or more sub-modules (here tables), of a single database, or these may be separate databases. Other tables may be constructed from data within the database (e.g. contemporaneously) as would be understood by someone skilled in the art. In the description above and below, the term ‘table’ will be used to refer to these data holding components.

For simplicity, various connections between the control module 40, payments module 50, notifications module 60, jobs table 70, available services table 80 and prices table 90 are not shown in FIG. 1.

In the following description, a ‘supplier’ (also known as a service provider or a professional) may refer to an individual who provides services, or to a business, e.g. an incorporated company or an association of individuals, such as a partnership or trade association, providing multiple separate individuals to provide services. Thus, the term supplier may refer to an individual when scheduling and providing services, or it may refer to a supplier business which employs or is associated with individuals who provide services. The term supplier is not intended to be limiting unless the context indicates otherwise. Services are typically provided in one or more unit(s) of activity each referred to herein as a ‘job’. Each job involves provision of services by a supplier to a customer. Thus, a job is a relation between a customer and a supplier, or suppliers, to complete a service. In other words, a job is the act of one or more suppliers carrying out the service for the customer.

In this description, various ‘forms’, e.g. wanted services request form 12, additional information form 14, (negative) availability calendar form 16, modified services query form 18, ON WAY form 20, and job card form 22 may be provided. These will not be referred to below as ‘forms’ but it will be understood that these represent an aggregation or combination of information, in effect a ‘form’. The term ‘form’ is not intended to be limiting unless the context dictates otherwise. It will be understood that the information may be aggregated and/or combined in different ways for the same purpose, but the aggregations and combinations herein described are particularly advantageous.

Various such ‘forms’, or aggregations of information, are populated from the data and/or cookie and exchanged between the interface(s), module(s), and sub-module(s) where provided, (or indeed external modules where provided), of system 10 to facilitate ease of interaction between these. One form is a wanted services request 12, which is initially populated by a customer via a customer user interface 20. Wanted services request 12 typically comprises one or more of a service type, service descriptor, service location, and optionally schedule.

In this context, ‘service type’, means the type of service required by the customer. Similarly, by ‘location’ we mean the location at which the wanted services are to be carried out which may be at the customer's location, or at a supplier's location, or within a range of the customer's location, or within a range of the supplier's location. In this context, ‘schedule’ means the date, or dates, and time, or times, at which the customer would like the wanted services to be carried out. For example, a customer may require piano lessons every Tuesday at 4 pm for an hour, each Tuesday has a unique date, and the date time is that unique date, and the time is 4 pm.

Within this disclosure, the term ‘date time’ may be used to refer to information specifying both a date and a time within the local time frame in use (e.g. GMT, GMT+1, CET etc) for the customer and more usually the customer and supplier. This choice of local time frame may form part of that user's user data.

In this disclosure, ‘price’ may mean preliminary price, or final price, or revised preliminary price, or revised final price. In this disclosure ‘job status’, means the status of the job, e.g. initial enquiry, job booked, job pending confirmation, job complete.

Optionally, a further ‘form’, the additional information form 14, may be used to modify the wanted services request 12 and/or to provide additional information for example, for uploading one or more photos, regarding the wanted services, e.g. a photograph of a leaky tap. The additional information form 14 may comprise, or be part of, the wanted services request 12, (or vice versa), or may be separate from it.

An availability calendar ‘form’ 16 (for example, a negative availability calendar form 16 for recording when a supplier is not available) is provided to allow a supplier, such as an electrician or plumber or piano teacher, to upload their availability. Thus, using the availability calendar 16, a supplier may state when he is available, or, more preferably, he may block out unavailable time slots and dates using such a negative available calendar ‘form’ 16 within an available services table 80 (which may be known as an available supplier services table).

A modify service request form 18 may, if required, be completed by a supplier via the suppliers' user interface 30. A job card form 22 is created by the control module 40. This may sit within a jobs table 70 if one is provided at least in part. In one embodiment, the job card form 22 is created contemporaneously each time a user (e.g. a customer, supplier or administrator) wants to see it and/or drawn from a row in the database. The job card form 22 may be created by the control module 40. Initially at least, information for a job card 22 may be stored in a cookie. The job card 22, referred to below as a job card 22 (the aggregation of information associated with a job) may be requested contemporaneously from multiple tables within the relational database, e.g. from available services table 80 and, from price table 90, and optionally also from a payments module 50, a notifications module 60, a tracking module 65 and/or fulfilment fees table 75 (or indeed a fulfilment fees module). Alternatively, or in addition, this information is stored within a jobs table 70 provided for this purpose.

In one embodiment, prior to the creation of a job card 22 within the database, this information is known as a wanted services request 12 and may be stored initially within a temporary cookie on a customer's computing device. Once a job is confirmed as being scheduled, and with payment information from the customers in place, the information may then be stored in the database as a job card 22 e.g. within the jobs table 70, at least in part. The wanted services request 12, and later job card 22, may include one or more pieces of information such as segment (i.e. the category of services required e.g. household utility services), service type, service location, schedule, price, and job status. Thus, it will be understood that, an initial wanted services request 12 from a customer results in a service type being identified, which later may be termed a job type when a job is formally scheduled to take place.

A supplier update location form 24, here in the form of an ‘ON WAY’ button, may be provided indicating whether the supplier is ‘ON WAY’ to the job. Similarly, a customer update(s) location form 26, here in the form of an ‘AT HOME’ or ‘ON WAY’ button, may be provided indicating whether the customer is at the job location (e.g. at home) or on the way to the job location (e.g. at the supplier's location or a mutually agreed further location, e.g. a sports venue).

To open an account, a customer uploads various pieces of information, such as name, location information, such as an address where services are to be provided and/or the customer's contact address, and optionally, payer information for payment upon completion of services. This upload of information by the customer to create an account may take place at various points throughout the job creation process, and/or throughout an account opening process, as will be understood from this disclosure. To open an account, a supplier may similarly upload various pieces of information including name and location information, such as address, and/or range of locations where the services are to be provided and/or contact address, and optionally payee information, for receiving payment upon completion of services. Various other types of information to be uploaded may be available to customer and/or supplier. For example, each may choose whether and/or how to receive notifications, e.g. via the user interface and also, for example by email, text message and/or messaging service. Each may choose whether to allow tracking information to be provided in the run up to a job being carried out.

Both customers and suppliers, and indeed optionally administrators, may be allocated unique user identifiers and user type identifiers. This means that the same user interface, and/or other modules each with various options switched on or off, depending on user type, may be used by each user type (administrators, suppliers and customers), or these may be a default user type.

As described above, a supplier may be an individual or a business supplier, e.g. an incorporated company, or an association of individuals, such as a partnership. Where the supplier is a business supplier, e.g. a incorporated company with individual employees, or an association of individuals, an availability calendar for each individual capable of providing services from that business supplier (e.g. the company or association) may be provided through a single supplier user interface. Nevertheless, each individual associated with a business supplier may have their own user interface which is typically associated with a business supplier user interface. Where a supplier is an individual, typically one availability calendar will be provided per supplier user interface. However, multiple calendars (one for each individual) may be accessible by a business supplier user interface. Thus, there is preferably a one-to-one correlation between individuals available to supply services and availability calendars. Indeed, individuals may be able to provide services through more than one supplier (e.g. through more than one company). In which case, each individual may have a single availability calendar that is associated with more than one supplier user interface. Each individual may have their own individual supplier user interface or be associated with a primary business supplier, e.g. as a main ‘controlling’ supplier user interface, with a single availability calendar with which other business suppliers may be associated and can access, to book that individual's time for providing services. Thus, in various embodiments, the invention provides a method for one (business) supplier to provide multiple individuals to supply services and/or a method for one individual to work with several different suppliers. This is made possible by creating a unique user identifier per individual and associated tables for use within a relational database to facilitate that individual providing services via multiple suppliers, and each supplier being able to access multiple individuals to provide services on their behalf.

As a time reduction measure for helping suppliers, various types of suppliers may have their availability initially pre-populated. For example, in-home suppliers, such as carers for providing personal care services, may have their initially pre-populated unavailability scheduled as 10 pm to 7 am, because the remainder (7 am to 10 pm) is the time period over which home caring services are more typically provided. A supplier providing driving lessons or piano lessons may have the calendar pre-populated with the time 9 am to 7 pm marked as being available, and the calendar outside these times marked as unavailable. For more utility type services such as plumbing, electricity or heating installation and repairs, washing machine installation and repairs, home computer installation and repairs, etc., the unavailability pre-entered into the calendar may be 5 pm to 8 am with available time being 8 am to 5 pm.

Such pre-filled ranges of availability (or preferably pre-filled ranges of unavailability) for different types of supplier make it easier for the suppliers to enter their actual unavailability (or availability) into the calendar. It will, however, be possible for the supplier to change the pre-populated range of days and typical hours on which they are normally available. For example, some suppliers may be willing, or indeed required, to provide services overnight and/or the weekend whereas others may not be willing, or required, to do so. Thus, a supplier (or each individual associated with a business supplier) will be able to adjust their pre-filled calendar days and pre-filled time slots with a range of available days and time slots of their choice. Once this background level of availability is set, suppliers (or each individual) will also be able to block out time that they have already committed to other activities. For example, they will be able to block out time that they are not able to provide services because of other commitments. Advantageously, once an appointment for a supplier (which supplier may be an individual supplier or an individual associated with a business supplier) to carry out a job has been agreed within the system 10 of the present invention, the suppliers' availability calendar will be automatically updated within the available services table 80 by control module 40 to block out the expected time for the job. Where an individual supplier works with more than one business supplier, their availability calendar (and/or calendars for each supplier) may be automatically updated with the system 10 of the invention.

Each supplier, or optionally, each business supplier, updates their location, and location range, when they first set up a new supplier account, or added a new individual to a business supplier account, and at pre-determined points thereafter should the supplier wish to do so. On opening an account, the supplier, or optionally the business supplier or individual for a business supplier, uploads their skill(s), location, location range, and initial schedule, or adjusts the initial pre-filled schedule for that type of supplier, so that the available services table 80 can be populated with an entry for that supplier (or mutatis mutandis that individual for a supplier), including their skill(s) e.g. from a pre-set list, location, location range and availability schedule. Here or elsewhere, the service types may be associated with skill(s) available to be chosen. There may be an option for the supplier to enter and/or upload their accreditations, and a checking accreditation module may be provided as part of a supplier onboarding process.

In step 1a, a supplier uploads their availability to availability calendar 16 via a supplier user interface 30. Typically and preferably, the information uploaded is negative availability. In other words, unless the time is blocked out by the supplier, the availability calendar 16 indicates the supplier is available for provision of services. This means that suppliers (or individuals of suppliers) do not need to enter time blocks that are available beforehand, but rather time blocks that are unavailable. This reduces the steps a supplier must take to complete, and/or update, their calendar.

In step 1b, a customer uploads a wanted services request 12 requesting a service of a service type (e.g. fixing a leaky tap lies within plumbing services) via customer user interface 20 to control (matching and selection) module 40. Wanted services request 12 comprises various pieces of information such as service descriptor and/or service type, location, optionally location range (e.g. piano lessons within 5 miles of home) and, optionally, schedule (e.g. a requested appointment date and time for carrying out the service or more preferably a requested time period for delivery of services, although neither is necessary in a preferred embodiment of the invention) as well as the identity of the customer requesting the information (e.g. a unique user identifier or unique customer identifier). As will be described later, advantageously, when initially uploaded and processed, the wanted services request 12 does not include a schedule e.g. an appointment date and time, or preferred time range. This counterintuitive approach facilitates a swifter resolution of the customer supplier interaction and reduced use of computing facilities. The preferred method of the invention results in fewer user input steps and a swifter offer to the customer as a result of a wanted services query 12.

Once control module 40 has received a wanted services request 12 it carries out two activities, preferably, and advantageously, in parallel.

On the one hand, typically in parallel with a step of obtaining a price in step 3a described later (e.g. a preliminary price), the control module 40 will, in step 2a, request one or more supplier(s) from the available services 80. The request for a supplier will use the service type in the wanted services request 12 to request a supplier type by the skill set delivered to the available services table 80 by the supplier when the supplier sets up their account (or mutatis mutandis that individuals' account for a business supplier). Further, the control module 40 matches the requested location, or location range of the wanted services request 12 with the location, and/or location range within the available services table 80.

Thus, in step 2a, control module 40 requests one or more types of supplier with relevant skill(s), location, and/or location range, and optionally availability in their schedule, to provide the services in the wanted services request 12, i.e. to provide requested services (of that service type) at the specified location, or within the specified location range, optionally at the specified date and time requested within the wanted services request 12. More than one supplier of differing types may be requested at the same time in one process flow should these be required, for example both a joiner and electrician may be requested if the service is to install a new kitchen, or both a hair stylist and nail technician if the wanted service is a beauty makeover.

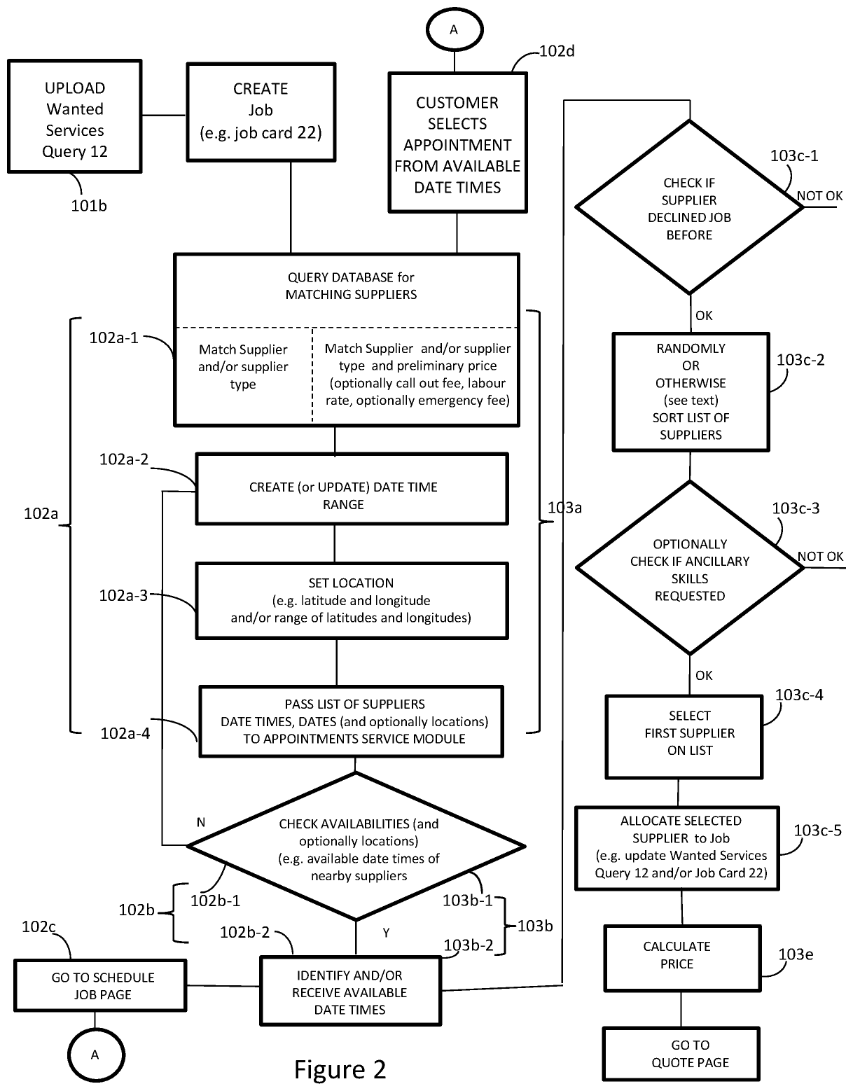

In various preferred embodiments, instead of the customer immediately requesting a specific date and time for the provision of services (in the wanted services request 12), the system 10, instead carries out an additional process which results in a reduction in user interface steps for a customer, and overall improved efficiencies in use of computing resources. The additional process is shown in FIG. 2. This will be described in more detail later but may be summarised as follows, the control module creates a predetermined date time range (a predetermined time period) based on the wanted services request 12 e.g. based on the date and time stamp of the wanted services request 12. This predetermined period may start 2 days or 36 hours for example after submission of the wanted services request 12 and may terminate e.g. 1 or 2 or 3 hours days or weeks later. Indeed, as will be described in more detail later, the control module 40 queries the database using the appointments service module 45 for matching supplier types, based on the service type, in the wanted services request 12, and retrieves the wanted supplier type(s). Typically at the same time, the control module 40 carries out the additional process to retrieve the availabilities of potential suppliers with the right skills near the requested location that have availability in their schedule within the predetermined time period to carry out the requested service so as to provide the customer with a range of availabilities associated with one or a number of potential suppliers with the right skills near their requested location. Next, a customer selects an appointment and this process is repeated at this now selected appointment time to re-check availabilities of potential suppliers and to select (e.g. randomly) a supplier who is allocated to the job at the selected appointment time (or to select and allocate a pool of available suppliers e.g. of differing supplier types, if more than one is required).

Turning back to FIG. 1, in step 2b, one or more suppliers matching the wanted services request 12 and in particular the supplier types capable of providing the wanted services (determined by skill set of such supplier types and service types of the wanted services) are provided to the control module 40. If more than one supplier per supplier type is provided then, optionally in step 2c, a supplier for each wanted supplier type is selected according to a pre-determined algorithm, or randomly. Optionally, this selection takes place in the control module 40, alternatively or, in addition, this selection is provided to the control module 40. The pre-determined algorithm may operate by one or more of: randomly arranging, matching of ancillary skills, sorting alphabetically, sorting geographically (e.g. closest), selecting in turn (available suppliers are selected one after the other), most recently used for a job of that type, least recently used for a job of that type, and so on, to select a supplier for a job.

On the other hand, in step 3a, control module 40 (or as will be described later the appointments module 45) requests (or determines) a preliminary, or final, price for the requested job from prices table 90 (and/or from information associated with the service type and supplier type). Thus, the wanted services request 12 preferably contains enough information (e.g. a service descriptor, or more preferably a unique service type identifier, which may be associated with a service descriptor, to be able to match the requested service with a corresponding service type in the prices table 90. The wanted services request 12 is designed to provide and/or accept a wide but, nevertheless, delimited range of service types, or job descriptors, to a customer to facilitate the possibility of a match between the requested service in the wanted services request 12 and the service types available in the prices table 90. If a corresponding service type is not available in the prices table 90, a query is raised with a customer, and/or with an administrator, and either further input from the customer is sought (typically prior to, or immediately after, initial submission of the wanted services request 12), or a control module 40, or an administrator, addresses the issue by selecting an appropriate corresponding service type that most corresponds to the requested job. Indeed, the control module 40 may facilitate the selection of an appropriate ‘next best’ corresponding service type if a corresponding service type is not available Thus, in one way or another, in step 3b, control module 40 gets at least a preliminary price from the prices table 90 for the service type in the wanted services request 12.

This preliminary price may comprise an expected time to carry out the service, which may be combined with the rate for labour for the supplier type to deliver that service. Optionally, the prices table 90 may include material prices for each job type. Optionally, within price table 90, or optionally in a separate fulfilment fees table 75, additional fees may be provided, e.g. a system fee, application fees, module fees (e.g. for a payments application to provide a payments module 50, or for a notification application to provide a notification module 60, or a tracking application to provide a tracking module 65, and so on.) Thus, fulfilment fees may be retrieved in steps 3c and 3d.

Once a supplier or supplier(s) with the correct skill(s), location, location range and availability within their calendar schedule has been selected for a proposed job, the control module 40, in step 4a, creates a preliminary job card 22 for the proposed job, for this as yet unscheduled as yet unaccepted job which may be stored in a cookie. Preliminary job card 22 comprises aggregate information, i.e. a combination of information, such as a unique identifier, supplier type, service type, service location, the selected available appointment time, preliminary and/or final service price (this may include the price paid to the supplier, and the price paid by the customer, which is typically the price paid to the supplier for labour, travel costs, call out fee plus any material costs, plus system fee, fulfilment fees, and any necessary taxes), and job status. Indeed, the price may be associated with a supplier type and service type as described later.

Typically, this preliminary job card 22 is formed contemporaneously, with control module 40 pulling various strands of information from various tables within the database to form the job card 22. In this way, the job card 22 presented to users (e.g. to customers and suppliers) is likely to be up-to-date and accurate. The predetermined time period may be dynamic, i.e. it may vary depending upon one or more urgency settings associated with the wanted services request 12 and/or the service descriptor and/or service type.

At this stage, the preliminary job card information may be stored as a cookie on the customer's computing device. Later, once the customer has agreed to the price and also preferably uploaded payment information if not done so already, the job is formally scheduled and an entry is created in the database. Nevertheless, this entry may not hold all the job card information, but rather contains enough to be able to compile contemporaneously job card 22 when required from various tables within the database. This use of a cookie avoids temporary entry in the database of a preliminary job that may not be accepted by a customer and so reduces the risk of errors through having an unconfirmed job entry in the database and the amount of storage required.

In step 4b, the preliminary job card 22 containing available appointments and preferably also the price of the service is delivered to the customer at least via the customer user interface 20 and/or other means, e.g. via email, text, or other notification and/or messaging service (as specified by the customer). The sequence of steps followed by the invention is very quick and appears virtually instantaneous to a customer after submission of a wanted services request 12. Thus a customer is presented with available appointments, and preferably also, a price almost immediately.

In step 4c, the customer selects a proposed appointment date and time and in doing so accepts the preliminary job card 22 (which includes available appointments and price information) proposed by the control module 40. This is a first virtual handshake indicating an offer to, and acceptance by, a customer. Once the customer has accepted the proposed job card 22, in step 4d, the control module 40 requests the payment details from the customer. It is intended that the collected payment details would not be used to take payment from a customer until the job has been completed, and this has been confirmed by both customer and supplier, as will be described later. In step 4e, payments module 50 receives payment details from the customer. This is a second virtual handshake reflecting confirmation by the customer of the first handshake. Once payment details have been taken, the job card status may be updated to ‘JOB SCHEDULED—AWAITING ACCEPTANCE FROM SUPPLIER’. At this stage, an entry relating to the now scheduled job is entered in the database.

In step 4f, job card 22 is delivered to the supplier and confirmation of acceptance of the job is requested within a pre-determined time limit, e.g. 3, 4, 5, 6, 8, 12, 24, or 48 hours. Other time limits are possible. The pre-determined acceptance time limit for job acceptance may be dynamic, i.e. it may vary automatically depending upon the time until the job is scheduled to take place. Thus, if a job is requested within the next 12 hours, the pre-determined acceptance time limit for the supplier to accept the job may be reduced to say, 1 or 2 hours. If the job is not accepted by the supplier within the pre-determined acceptance time limit, then the job may be offered to another available supplier of the same supplier type. Similarly, if the job is not scheduled to be carried out for one or two weeks' time, or even more, then the first offered supplier may be given a longer pre-determined acceptance time limit of say 24 or 48 or 72 hours to accept the job, before a further available supplier is offered the job. In step 4g, the job, as presented to the supplier on job card 22, is accepted by the supplier. This is a third virtual handshake indicating an offer to, and acceptance by, a supplier. The job status on the job card 22 may be updated to ‘JOB SCHEDULED—ACCEPTED AND CONFIRMED BY SUPPLIER’, and this may be passed to the customer via the customer's chosen notification methods, and typically, at least, via the customer's user interface. Where the supplier is a business supplier, it may be arranged that one or both the business supplier, and the individual carrying out services as a supplier for that business supplier, may need to accept in step 4g.

In optional step 5a, a customer may change the wanted services request 12 by modifying the requested services or uploading additional information, e.g. in the form of a photo of the services required in the job, for example a photograph of a leaking tap, corroding pipe, worn wiring, broken washing machine, etc.

Before, and/or after, acceptance by the supplier in step 4g, and indeed upon arrival to carry out the job, the supplier may raise a modify service request 18, in step 5b. This enables a supplier to query matters that may affect the time taken, and/or material used, and/or nature, and/or complexity of the job, which may affect the price. Such a modify service request 18 may be initiated by the supplier in step 5b, before accepting the job, and/or after accepting the job for example, if additional information 14, e.g. a photo regarding the wanted services has been uploaded by a customer, in step 5a.

If, in step 5b, a supplier submits a modify service request 18, for example, after acceptance of the job by the supplier, the control module 40 and/or appointments service module 45 may request an updated preliminary price from prices table 90, in step 5c, e.g. because the materials required have changed, and/or further labour is required and/or even a different suppier type is required and/or the job location has changed. If such a request takes place, an updated price may be delivered to control module 40, in step 5d. Where a separate fulfilment fees table is used, optionally in steps 5e, and 5f, the control module 40 requests, if appropriate, an updated fee from fulfilment fee module 75. Optionally, if required, control module 40 calculates an updated final price. In step 5g, the job card 22 is updated. For example, minor changes, such as changes in colour of something are unlikely to affect the final price(s) presented on a job card, however, a variation in the services to be delivered, and/or materials used, and/or length of time a job might take, and/or location of a job, are likely to require a change in price. Indeed, a customer (rather than a supplier) may also submit a modify service request 18 (e.g. via additional information query 14), similar to modify service request 18 from a supplier, and system 10 may then follow a similar series of steps. In either case, system 10 may seek updated preliminary price in step 5c, may obtain an updated price in step 5d, may seek updated fulfilment fees in step 5e, may receive updated fulfilment fees in step 5f, may update a job card in step 5g, and may deliver the updated job card 22 to the customer in step 5h. The updated job card 22 in step 5h may be delivered via the customer user interface 20, and/or via email, text or other messaging means selected by a user. In step 5i, the customer accepts the updated job card 22. This is a fourth virtual handshake indicating an updated offer to and acceptance by a customer. In step 5j, the updated job card 22 may be delivered via the supplier user interface 30, and/or via other means, e.g. email, SMS text messages or other messaging means (e.g. as preselected by the supplier). In step 5k, the supplier accepts the updated job card 22. This is a fifth virtual handshake indication an offer to and acceptance by a supplier.

Once the date and time approaches for the supplier to carry out the job, a series of notification steps kicks in. These notification steps may include a reminder from the notifications module 60 (e.g. in step 6a-1) to the supplier (e.g. an individual) via the supplier user interface 30, and/or via other means e.g. email, text message, or other messaging means, to prepare for carrying out the job. Typically it is expected that the supplier will regularly review their scheduled jobs within system 10, via the supplier user interface 30 e.g. by reviewing their allocated jobs in the jobs table 70 to prepare for upcoming jobs in advance, e.g. to ensure they have the appropriate materials at hand. This is because if they are carrying out several jobs in a day, and several jobs in a week, they may not want multiple reminders for each job, potentially clogging up their email, and/or other messaging systems. They may, however, choose to retain a limited number of selected remainders, (e.g. for the next day, 48 hours, or week and/or 1 reminder per job) to be presented to them in their supplier user interface 30. It is understood that a jobs table 70 may not be provided in practice. Rather, a series of jobs, with unique job identifier, allocated to that supplier's unique supplier identifier may be created from time to time e.g. contemporaneously, and/or periodically, and delivered to a supplier as described above.

Similarly, depending upon the notification status set by the customer via the customer user interface 20, notifications module 60 may send reminder notifications in step 6a-2 to the customer via their user interface, and optionally also to the customer more directly, e.g. via email, SMS text or other messaging means. Indeed, advantageously, where both customers and suppliers (or individuals at a supplier business) are provided with unique user identifiers (user ID's), one notifications process, albeit with various modifications e.g. depending on user type, can be used by both types of users, reducing the computational resources required.

As the supplier departs to travel to the job location if required, optionally in step 6b-1, the supplier may press a ‘button’ 24 labelled ON WAY or similar wording. Optionally, in step 6b-2, the notifications module 60 may then deliver this information via customer user interface 20, and/or via email, and/or text and/or other communication channel, to the customer that the supplier is on their way.

Alternatively, or in addition, optionally, a customer is provided with an ON WAY (or similar wording) ‘button’ 26 via customer user interface 20 which when pressed in step 6c-1 indicates that the customer is ‘en route’ to the job location. In step 6c-2, the notifications module 60 delivers this information to the supplier user interface 30, and/or, optionally, by email and/or text, and/or other preferred communication channel that the customer is on their way.

Typically, services are provided at the customer's usual location, however, services may also be provided at the supplier's location, or at a mutually agreed upon different location. In optional step 6d-1, a dynamic, real time map may be provided on customer user interface 20 which may be updated periodically to show the supplier's location and that they are indeed ‘en route’. Indeed, optionally a tracking module 65 may be used which the supplier (and indeed the customer) may opt into to provide GPS, or other tracking of their location (e.g. via their mobile phone and the mobile phone network) to facilitate updates of the interactive map. Typically, the supplier will have had to opt into this notification choice to be made available to the customer (and optionally vice versa).

In optional step 6d-2, customer location tracking may be provided to a supplier. This may not be required but could be particularly helpful where the job location is at a different place from the customer's normal location Indeed both ‘buttons’ 24 and 26 and associated notification steps above may be used where the job location is at mutually agreed separate locations, e.g. a sports centre.

When the supplier has arrived at the job location, the supplier carries out the services specified for the job. If upon arriving at the job location, the supplier considers that a different job needs to be carried out than that which had previously been accepted, the supplier may submit a modify service request 18, in step 5b, as described above. Also as described above, this may result in an updated price being requested and delivered in step 5c and 5d from the prices table 90 (and optionally steps 5e and 5f via fulfilment fee table 75) by control module 40. The job card 22 may be updated with the updated price and then delivered in step 5h to the customer with the updated price. Acceptance in step 5i by the customer is then typically required before the supplier will carry out the modified job. This is a further virtual handshake indicating an updated offer to and acceptance of the job by the customer which may mirror the first virtual handshake (steps 4b (e.g. 4b-1, or 4b-2) and 4c above). Indeed, optionally, the supplier may be provided with the updated job card 22 in step 5j, and asked to accept in step 5k. This is a further virtual handshake indicating an updated offer and acceptance of the job by the supplier which may mirror the third virtual handshake (steps 4f and 4g above). This modification interaction takes place typically relatively quickly, and usually virtually instantaneously. Thus, this can take place at the job location, immediately before a job is carried out. Indeed, the customer is in control throughout whether or not to accept the job, or the now updated job which has an updated price. This removes the need for the supplier to go away and resubmit a quote, and the delay of to-and-fro negotiation between the customer and supplier, enabling a price to be decided upon quickly. Indeed, as explained above, a modified services request 18 can also be submitted by a customer, again either before a supplier arrives to do the job, or after the supplier has arrived to do the job. This modification may result in a new price and both parties (customer and supplier) would agree (again in further handshakes 5h and 5i, and then 5j and 5k respectively) to accept the updated job card 22 with the updated price before work on the job begins, e.g. from prices table 90. This system has benefits for both customers and suppliers.

Once the job is complete, in step 7a, the customer updates the job card 22 via the customer user interface 20 to indicate the job is complete. Optionally, a JOB COMPLETE button 25 may be provided, either on the customer user interface 20, and/or on a job card 22 presented on the customer user interface 20. Similarly, in step 7b, a JOB COMPLETE button may be provided, either on the supplier user interface 30 and/or on the job card 22 on the supplier user interface 30. This final handshake (as steps 7a and 7b are taken by both customer and supplier respectively) can happen relatively quickly within a few minutes of job completion. Again this has benefits for both customers and suppliers.

There may be an option for the customer and/or the supplier to provide feedback (as appropriate) on the job carried out and/or on the supplier and/or on the customer and/or on the system 10 itself. For example, a feedback module may be provided.

Once both customer and supplier have updated the job status to JOB COMPLETE, this information is received by the control module 40, in step 7c. Following this, the payments module 50 is activated, in step 8a. In step 8b, payment is taken from the customer by the payments module 50 to pay the final price. In step 8c the suppliers part of this payment, e.g. referred to as a preliminary price, is made to the supplier. There may be an optional ‘cooling off’ period before payment is made to the supplier e.g. 3 to 7 days for house utility repairs, or 1 to 3 days for music, sports lessons. The payments module 50 may take payment in the pre-agreed format and method set up by the customer initially, for example this may include by debit card, credit card, bank transfer, e-payments vehicle such as PAYPAL or STRIPE and so on. In step 8c, payment is made to the supplier via the desired payment method such as crediting a bank account, a credit card, bank transfer or e-payments vehicle such as PAYPAL or STRIPE and so on.

In step 9a, an invoice is sent to the customer by payments module 50. This is delivered via the customer user interface 20 and/or, optionally, via an email or text or other notification means as selected by the customer. Similarly, a reverse invoice is sent to the supplier, in step 9b which is typically delivered to the supplier user interface 30, and/or optionally via other delivery means such as email and/or text, as selected by the supplier.

Referring now to FIG. 2, system 10 of the invention is described for use in methods and apparatus of the invention. Steps described with reference to FIG. 2 are broadly equivalent to comparably numbered steps in FIG. 1. For example, step 101 and sub-step 101b in FIG. 2 are broadly comparable to steps 1 and 1b in FIG. 1. Steps 102a, 102b, 102c, and 102d are broadly comparable to steps 2a, 2b, 2c, and 2d in FIG. 2. The description with respect to FIGS. 2 and 3 provides further detail of how the system 10 of FIG. 1 may be used in one or more practical embodiments.

In FIG. 2, in step 101b, a customer enters a service type or service descriptor representing a type of service, i.e. a job type with a corresponding serviceID. In more detail, the customer fills out all the fields in the form on the job description page and clicks submit to submit a wanted services request 12. The wanted services request 12 is sent to the ‘scheduling’ action of the control module 40 also known as a jobs controller. A connection is opened to the database (and thus to multiple virtual ‘tables’ within the database some of which are shown in FIG. 1). The customer input data in the wanted services request 12 is retrieved (e.g. from a cookie, in which it has been stored so far), and the control module 40 prepares the customer input data e.g. service type, and location and/or location range for appointment service module 45. The appointment service module 45 is a module that finds suppliers based on time, gets available times based on the supplier's data, and handles declining of appointments, and rescheduling of appointments. In step 102a, control module 40 requests a list of supplier types capable of completing that type of service from the database. The results for this request are delivered to the appointment service module 45 (see FIG. 1). Appointment service module 45 runs a number of processes and preferably runs at least two processes. Appointment service module 45 runs a first process, a ‘GetAvailableAppointments’ process and a ‘GetProfessionalsforAppointmentTime’ process which advantageously have several common features. Here, the term ‘professionals’ refers to the ‘suppliers’ and may be used in the following description.

Thus, control module 40 can use the appointment service module 45 for more than one purpose, re-using steps within each process. In the first ‘GetAvailableAppointments’ process, the appointment service module 45, in step 102b uses the list of supplier types provided in step 102a, and searches for suppliers of each type in the available services table 80, and obtains their schedules within a predetermined date time range to create a list of available dates and times.

The control module 40 prepares the data for the appointments service module 45 in the following way:
a. in step 102a-1 it prepares a list of ‘ProfessionalMatchRequests’ by querying the database for records (e.g. rows) and in particular a ‘service professional types’ table where the ‘service ID’ is equal to the ‘service ID’ provided by the customer through the selected service field. The customer has typically selected a service with a ‘service ID’ which has been retrieved from a ‘services’ table.
b. In step 102a-2, a date range is created, e.g. a ‘start date’ is set to the current date plus a predetermined date time period e.g. 2 days or 34 hours or 36 hours. The start date may be set dynamically e.g. to 1 day, or ½ a day, or 1 hour, or 6 hours, or longer, e.g. one week, etc. This may depend upon the urgency requested by the user in the wanted service request 12 on the form on the job description page. An ‘end date’ is based on the start date plus a predetermined data time period e.g. 7 days, 14 days, 21 days or 28 days, or even 12 hours or 1 day or 2 days if the matter is urgent for example an emergency call out. This period may be varied depending upon information filled in by the customer in the wanted services request 12 on the job description page. Typically, however, the start date and end date are set at least initially by administrators within the system, e.g. for particular service types and/or service categories. These may be varied by a customer by toggling an emergency call out button to on, and more urgent pre-sets start and end dates may then be used by the system.
c. In step 102a-3, a location is set. Typically, —a ‘latitude’ and ‘longitude’ are set to the comparable values (e.g. address and/or postcode) provided by the customer on the wanted services request 12 (which may be filled from the customers address). Typically, a ‘job’ cookie will be used to hold this information. Next the ‘ProfessionalMatchRequests’, predetermined date range, and location are sent to the appointment service module 45 in step 102a-4.
d. In step 102b-1 the ‘GetAvailableAppointments’ process within the appointment service module 45 returns a list of available times in step 102-b2 for which suppliers with the required skills i.e. the requested supplier type or types (if more than one type of supplier is required to carry out that service type are available at the requested location or within the requested location range).
e. If any such available times for the requested supplier types are returned, this returned data is passed to the ‘schedule job’ page in step 102b-2.
f. If no available times are returned, a predetermined further period e.g. 14 days are added to the date range by the control module 40, and the query is run again (in steps 102a-2 and 102b-1). Thus, steps 102a and 102b may be repeated at least partly. Indeed, these may be repeated again with either the same predetermined e.g. 14 day date range in case a new supplier has come on board or new availabilities have become available. or different (later) date range. If, after the selected number of repetitions of steps 102a and 102b, no available list of times are returned, the customer is added to a waiting list so that they can be notified of any matching suppliers in the future. Typically, also an error is generated, and the customer is re-directed back to the ‘job description’ page. The system 10 checks on a regular basis and/or when a new supplier is added to see if a matching supplier is now available.

The connection to the database is then closed. If, however, a list of available times are returned from appointment service module 45 to controller module 40 in step 102b, this returned data is passed to a ‘schedule job’ page in step 102c for completion by the customer. Thus, the method of the invention in various embodiments provides for creating a proposed job for providing a service and virtually immediately showing the schedule of available appointments for that proposed job to the customer. Further preferably, the customer selects an appointment date below and time for a job from the available appointments from all the available suppliers in their area once the appointment is selected, the system 10 then selects a supplier as described below for that job by the system 10. This has benefits for customers and suppliers requiring fewer interactions.

In step 102d, the customer selects one of the offered appointments, i.e. date and time on the ‘schedule job’ page and submits (typically clicking a next button). The request generated through the action of the customer submitting a selected date and time is again sent to the ‘scheduling’ action of the control module 40 for the ‘GetProfessionaslFor AppointmentTime’ process. A connection is again opened to the database, e.g. to the available services table 80. The same user input data entered by the user in step 101b is retrieved, e.g. retrieved from the cookie it has been stored in so far. The control module 40 prepares a list (or rather re-prepares a list) of ‘ProfessionalMatchRequests’ by querying the database for records and in particular a ‘service professional types’ table where the ‘service ID’ is equal to the ‘service ID’ provided by the customer, through the submitted form i.e. the service type.

The ‘ProfessionalMatchRequest’ is matched by comparing the ‘service ID’ of the column, in the relevant(s) table (e.g. the supplier type table as before, and now a ‘service type price’ table (not shown)), and the ‘service ID’ of the customer selected service descriptor or service type (which is typically stored in a cookie processed earlier). If a match is found the row is retrieved. The ‘service professional types’ table may, alternatively, or in addition also reference a price (e.g. a regular price (regular labour rate), a call out fee, an emergency price (emergency labour rate), and emergency call out fee). Optionally, in addition, the control module 40 queries a ‘service professional type ancillary skills’ table (not shown) in the database.

The ‘service price’ table may provide a price in the form of expected time for a particular service (e.g. replacing a tap and a price for materials).

Thus the ‘ProfessionalMatchRequest’ may now also return both a supplier type capable of providing the requested services with (e.g. continuing) availability at the now selected appointment date and time, and at least a preliminary price (e.g. of materials and labour) for that job. Thus (referring now to FIG. 1) a customer having now selected an appointment of date and time steps 2a and 2b (reserving a supplier) and steps 3a and 3b (obtaining a price) may be completed in one step, typically in one query of the database. Indeed, referring to FIG. 1, the price may be provided in the initial step (step 4b) along with available appointments, as also described in relation to FIG. 1, or the price may be provided in a step 4b-2) as described in in relation to FIG. 2.

Each ‘ProfessionalMatchRequest’ may now comprise the following data which has been retrieved from the database:
professional type ID;
optionally, requested ancillary skills ID;
professional profile ID (which may initially set to ‘null’);
call out fee;
materials cost;
regular price (typically regular labour cost)

In other words, this time around in step 102a-1, the ‘ProfessionalMatchRequest’ is put together by querying the ‘service professional type’ table in the database, and optionally also the price, e.g. the labour cost by querying ‘service supplier type table’ by supplier type and/or querying e.g. prices table 90 by services ID. In practice, the services ID in the ‘ProfessionalMatchRequest’ may be matched to the ‘services ID’ in a service type price table which may include the length of time for service to take, which together with the labour rate, call fee out fee if any, together with the fee layout etc. from the supplier type table can be used to calculate a price, essentially providing a prices table 90. The associated material cost, and optionally labour cost which may vary by both job type and/or supplier type are returned. The call out fee may be a fixed rate per mile, and/or may be a fixed call out rate retrievable from the available services table 80 and/or from the prices table 90. The now compiled ‘ProfessionalMatchRequest’ is passed along with the selected appointment date time (i.e. date and time), selected by the customer, and the location of the job into the appointment service module 45 in step 103a (see FIG. 2) It should be noted however that this step 103a is in effect a repetition (with somewhat different data) of step 102a-1 to 102a-4.

For some services, such as piano lessons or driving lessons, a length of time may be selected as part of the customer input data in the wanted services request 12

The appointment service module 45 carries out step 103b-1, identifies available times for each supplier type requested in the list of supplier types requested for that service.

Typically only one supplier type is needed e.g. piano teacher but occasionally, more than one type is required to provide the service requested e.g. joiner and electrician for kitchen installation. The appointments service module 45 searches for suppliers of that type that are a match for location, and the now selected date and time, in step 103b-1. These are reared by control module 40 in step 103b-2. Next, in step 103c-1, a check is made to see if a supplier has declined this specific job before. Next, in step 103c-2 a randomised (or otherwise arranged) list of supplier profiles is created from the available suppliers (for each type required for this service). Next, where ancillary skills are important, in optional step 103c-3 the first candidate supplier in the (preferably randomly) sorted list with the ancillary skills is selected as the allocated supplier (optionally for that supplier type if more than one supplier type is needed). If not then simply the first candidate supplier on the list is selected in step 103c-4. Once the first candidate from a randomised list (or an otherwise decided list as described above) is selected, then the unique identifier for that supplier (e.g. the unique supplier identifier) is added to the supplier profile ID in the ‘ProfessionalMatchRequest’.

If only one supplier type is identified as being required for that service ID, then at this point only one allocated supplier will have been identified. If however, multiple supplier types might be required to carry out a specific service, then a number of allocated suppliers may be identified at this point, each of whom may result from a ‘ProfessionalMatchRequest’ for that supplier type.

In step 103e, the price is calculated for one or more suppliers or supplier types (if required for that service) and shown to the customer via the customer user interface 20.

In summary, in various embodiments each wanted services request 12 results in one or more ‘ProfessionalMatchRequest’ e.g. if more than one supplier type is required for that job prepared by control module 40, and passed onto appointment service module 45. Appointment service module 45 does a number of things. It stores a job location, or location range, for later use. It stores a list of suppliers who have previously declined this job. It goes through each request in the passed in list of ‘ProfessionalMatchRequests’. For each ‘ProfessionalMatchRequest’ the appointment service module 45 searches the database's ‘professional profiles table’ for rows, which have matching supplier type IDs, a travel distance that is less than the distance between the supplier's location, and the job's location, and finally no conflicting unavailabilities. It then removes any suppliers from the list who were on the previously stored list of suppliers who have declined the job before. It then randomly sorts this list.

Optionally, if the list of supplier profiles is not empty and the customer requested ancillary skills, the appointment service module 45 will look at each supplier (also known as a professional) in the list starting at the top, and check if they have all the requested ancillary skills, and if they do, the requested supplier profile ID is set to the current supplier profile's ID i.e. the unique supplier identifier for that supplier. If the list of supplier profiles is not empty, and the previous optional step did not provide a result, then the appointment service module 45 picks the first supplier profile in the list and makes the supplier profile ID in the ‘ProfessionalMatchRequest’ to that first supplier profiles ID (i.e. to that supplier's unique supplier identifier).

By using unique identifiers, a common user interface for customers and suppliers can be used. Thus, customer user interface 20 and supplier user interface 30 may comprise several common components, or indeed be the same with various components activated (or not) depending on the user type (supplier, customer or administrator).

In various embodiments control module 40 is capable of handling multiple wanted services requests from the same customer at the same time, processing these in turn, e.g. within the appointment service module 45, one after the other, returning these in one step to a customer, rather than processing each ‘ProfessionalMatchRequest’ and returning it to the customer individually. Various other embodiments will be apparent to those skilled in the art from the present disclosure.

1. A computer-implemented method for requirement based intelligent resource allocation, the method comprising:
electronically receiving, via a distributed network, information associated with at least one supplier, the information associated with the at least one supplier comprising at least a supplier type identifier, supplier availability, and supplier location data;
storing the information associated with the at least one supplier in at least one database;
electronically receiving, via a customer device operably connected to the distributed network, a service requirement request (12) from a customer, the service requirement request (12) comprising at least a service requirement identifier associated with a required service request, and service requirement location data;
initiating a supplier allocation subroutine to query the database and identify potential suppliers for the service requirement request (12), wherein the supplier allocation subroutine is further configured to determine a match between the at least one supplier type identifier and the service requirement identifier, and the supplier location data and service requirement location data;
electronically retrieving the potential suppliers based on at least the match;
determining whether the potential suppliers satisfy one or more predetermined conditions, wherein the one or more predetermined conditions comprises availability within at least one predetermined time period;
transmitting control signals configured to cause the customer device to display the availability that satisfies the one or more predetermined conditions;
receiving, via the customer device, a customer selection, wherein the customer selection comprises an appointment having an associated date and time from the supplier availability associated with the potential suppliers that satisfies the one or more predetermined conditions; and
allocating the at least one of the potential suppliers based on at least the customer selection.

2. The method according to claim 1 further comprising:
providing, in the at least one database, associations between the supplier type identifier and a supplier type price, and between the service requirement identifier and a service price, and,
querying the database for the supplier type price and the service requirement price;
determining a price for the service requirement request based on at least the supplier type price and the service requirement price; and
providing the price for the service requirement request to the customer.

3. The method according to claim 2 further comprising:
receiving, from the customer device, an indication that the customer has accepted the price for the service requirement request.

4. The method according to claim 1 comprising:
after selecting the appointment, querying the database and identifying the potential suppliers for the service requirement request (12) by matching at least the supplier type identifier with the service requirement identifier, and the service requirement location data with the supplier location data;
determining whether the identified potential suppliers satisfy one or more predetermined conditions, wherein the one or more predetermined conditions comprises availability at the date and time of the selected appointment based on at least the match; and
providing, via the customer device, confirmation of the availability of the identified potential supplier at the date and time of the selected appointment.

5. The method according to claim 1 comprising:
providing, in the at least one database, associations between the supplier type identifier and least one supplier type price, and between the service requirement identifier and service price, and,
after selecting the appointment, initiating the supplier allocation subroutine to query the database and identify potential suppliers for the service requirement request (12) by matching the supplier type identifier with the service requirement identifier, and the service requirement location data with the supplier location data;
querying the database for the supplier type price and the service price;
determining whether the identified potential suppliers satisfy one or more predetermined conditions, wherein the one or more predetermined conditions comprises availability at the date and time of the selected appointment;
providing, via the customer device, confirmation of the availability of the identified potential supplier at the date and time of the selected appointment;
determining a price for the service requirement request based on at least the supplier type price and the service requirement price; and
providing, via the customer device, the price for the service requirement request to the customer.

6. The method according to claim 5 further comprising:
receiving, via the customer device, an indication that the customer has accepted the price.

7. The method according to claim 1 in which the service requirement request (12) is temporarily stored as a cookie in the customer device.

8. The method according to claim 1 further comprising:
after the step of selecting the appointment by the customer, allocating a unique job identifier to the service requirement request (12), and creating a job record in the database using the unique job identifier and the data in the service requirement request (12).

9. The method according to claim 2, further comprising
after the customer has accepted the price, or after the customer has accepted the price and entered payment information, allocating a unique job identifier to the service requirement request (12), and creating a job record in the database using the unique job identifier and the data in the service requirement request (12).

10. The method according to claim 2 in which the price for the service requirement request comprises at least one of:
a preliminary price associated with at least one of the supplier type and service type; and,
at least one of a system fee, a payment module fee, a notification module fee, a tracking module fee, a fulfilment module fee.

11. The method according to claim 1 in which the step of identifying at least one supplier comprises identifying at least one supplier type, and where two or more supplier types are required for a service requirement request, identifying a supplier for each supplier type.

12. The method according to claim 1 in which the service requirement identifier for the service requirement request is associated with one supplier type identifier.

13. The method according to claim 1 in which the service requirement identifier for the service requirement request is associated with more than one supplier type identifier.

14. The method according to claim 1 comprising:
determining that more than one supplier is available at the date and time of the selected appointment for the supplier type identifier; and
selecting the potential supplier for the supply type identifier either randomly, geographically, alphabetically, and/or in-turn.

15. The method according to claim 1 in which the at least one supplier, the customer, and an administrator are each assigned a unique user identifier and a unique user type identifier.

16. The method according to claim 1 in which location data of at least one of the supplier location data, a customer location data, the service requirement location data, and a job location data comprises at least one of a location and a location range associated with that respective supplier, customer, service requirement or job.

17. A computer program product comprising computer program code stored on a non-transitory computer-readable medium, said computer program product used for requirement based intelligent resource allocation, said computer program code comprising computer instructions to cause one or more processors to perform the operations of:
electronically receiving, via a distributed network, information associated with at least one supplier, the information associated with the at least one supplier comprising at least a supplier type identifier, supplier availability, and supplier location data;
storing the information associated with the at least one supplier in at least one database;
electronically receiving, via a customer device operably connected to the distributed network, a service requirement request (12) from a customer, the service requirement request (12) comprising at least a service requirement identifier associated with a required service request, and service requirement location data;
initiating a supplier allocation subroutine to query the database and identify potential suppliers for the service requirement request (12), wherein the supplier allocation subroutine is further configured to determine a match between the at least one supplier type identifier and the service requirement identifier, and the supplier location data and service requirement location data;
electronically retrieving the potential suppliers based on at least the match;
determining whether the potential suppliers satisfy one or more predetermined conditions, wherein the one or more predetermined conditions comprises at least one predetermined time period;
transmitting control signals configured to cause the customer device to display the availability that satisfies the one or more predetermined conditions;
receiving, via the customer device, a customer selection, wherein the customer selection comprises an appointment having an associated date and time from the supplier availability associated with the potential suppliers that satisfies the one or more predetermined conditions; and
allocating the at least one of the potential suppliers based on at least the customer selection.

18. A system for requirement based intelligent resource allocation, the system comprising:
a control module (40);
at least one database (70, 80, 90);
at least one user interface module providing at least one customer user interface (20) and at least one supplier user interface (30); and
an appointments service module (45);
further in which:
the control module (40) is configured for electronically receiving, via a distributed network, information associated with at least one supplier, the information associated with the at least one supplier comprising at least a supplier type identifier, supplier availability, and supplier location data, and for receiving, via a customer device operably connected to the distributed network, a service requirement request (12) from a customer, the service requirement request (12) comprising at least a service requirement identifier associated with a required service request, and service requirement location data;
storing the information associated with the at least one supplier in at least one database (70, 80, 90);
the control module (40) is further configured for initiating a supplier allocation subroutine to query the database and identify potential suppliers for the service requirement request (12), wherein the supplier allocation subroutine is further configured to determine a match between the at least one supplier type identifier and the service requirement identifier, and the supplier location data and service requirement location data, and electronically retrieving the potential suppliers based on at least the match;
the appointments module (45) is configured for determining whether the potential suppliers satisfy one or more predetermined conditions, wherein the one or more predetermined conditions comprises at least one predetermined time period;
the control module (40) is further configured for transmitting control signals configured to cause the customer device to display on the customer user interface (20), the availability that satisfies the one or more predetermined conditions;
the customer user interface (20) is configured for receiving a customer selection, wherein the customer selection comprises an appointment having an associated date and time from the supplier availability associated with the potential suppliers that satisfies the one or more predetermined conditions; and
the control module (40) is further configured for allocating the at least one of the potential suppliers based on at least the customer selection.

19. A system according to claim 18 in which
the control module (40) is configured for, after selection of the appointment by the customer, querying the database and identifying potential suppliers for the service requirement request (12) by matching at least one supplier type identifier with the service requirement identifier, and the service location data with the supplier location data; and,
the appointments module (45) is configured for determining the availabilities of the identified potential suppliers at the date and time of the selected appointment; and,
the control module (40) is configured for providing confirmation of the availability of the identified potential supplier at the date and time of the selected appointment to the customer user interface (20).

20. The system according to claim 19 in which
the at least one database (70, 80, 90) comprises associations between the supplier type identifier and a supplier type price, and between the service requirement identifier and a service price, and,
and the control module (40) is configured for querying the database for the supplier type price and the service requirement price;
and the appointments service module (45) is configured for determining the availabilities of the identified potential suppliers at the date and time of the selected appointment and for determining a price for the service requirement request based on at least the supplier type price and the service requirement price; and
and the control module (40) is configured for providing the price for the service requirement request to the customer.
